(19) United States
(12) Patent Application Publication
(10) Pub. No.: US 2007/0044055 A1
(43) Pub. Date: Feb. 22, 2007

(54) CLOCK SIGNAL DRIVER AND CLOCK SIGNAL SUPPLYING CIRCUIT HAVING THE SAME

(75) Inventors: In-Soo PARK, Gyeonggi-do, (KR); Jae-Hyung LEE, Gyeonggi-do, (KR)

Correspondence Address: MARGER JOHNSON & MCCOLLOM, P.C., 210 SW MORRISON STREET, SUITE 400, PORTLAND, OR, 97204, US

(73) Assignee: Samsung Electronics Co., Ltd., Gyeonggi-Do (KR)

(21) Appl. No.: 11/379,030

(22) Filed: Apr. 17, 2006

(30) Foreign Application Priority Data
Aug. 18, 2005 (KR) 10-2005-0075913

(51) Int. Cl. G06F 17/50

(52) U.S. Cl. 716/6

(57) ABSTRACT

A clock signal driver and a clock signal supplying circuit having the same are provided. An embodiment of the clock signal driver includes an internal clock driver for receiving a clock signal and a complementary clock signal, buffering the clock signal and inverting the complementary clock signal, and combining phases of the buffered clock signal and the inverted complementary clock signal to generate an internal clock signal. And the clock signal driver further includes a complementary internal clock driver for receiving the clock signal and the complementary clock signal, inverting the clock signal and buffering the complementary clock signal, and combining phases of the inverted clock signal and the buffered complementary clock signal to generate a complementary internal clock signal.

### CROSS-REFERENCE TO RELATED APPLICATION

This application claims the benefit of Korean Patent Application No. 2005-0075913, filed Aug. 18, 2005, the disclosure of which we incorporate by reference.

### BACKGROUND

1. Field of the Invention

The present invention relates to a clock signal driver and, more particularly, to a clock signal driver which corrects a clock signal pair having a distorted duty cycle from passing through a clock transmitting line pair to have a duty cycle of 50% and a clock signal supplying circuit having the same.

2. Description of the Related Art

In an input and output method for synchronizing data to a clock signal and then transmitting the synchronized data like data transmission between a memory device and a memory controller, time synchronization between the data and the clock signal is very important as the bus load increases and the transmission frequency becomes fast. That is, the time spend for the data to be loaded onto the bus should be compensated for in response to the clock signal to accurately place the data at an edge or center of the clock signal. To accomplish this, a phase locked loop (PLL) or a delay locked loop (DLL,) can be used, although the DLL is generally employed in memory devices.

In the case of a double data rate (DDR) device, where data is outputted at both a rising edge and a falling edge of the clock signal, when the duty cycle of the clock signal deviates from 50%, the width of the data output section at the rising edge and the width of the data output section at the falling edge become different. As a valid data window is defined by the width of the data output section having the smaller width, the valid data window may have a decreased width. Therefore, the timing margin of the memory device is decreased according to the valid data window, which may have a decreased width.

For the above reason, the PLL or DLL includes a duty cycle corrector (DCC) for correcting the duty cycle of the clock signal to generate a clock signal having the duty cycle of 50%.

However, as memory devices have higher and higher capacities, the length of the clock transmitting lines for providing the clock signal to internal circuits of the memory device is gradually increased, and thus a problem occurs where the duty cycle is distorted while the clock signal passes through the clock transmitting line.

That is, since the clock signal is weakened when the length of the clock transmitting line is increased, a buffer is inserted at a prescribed interval to prevent the clock signal from being weakened. However, the buffer may have a different rising edge occurring time (time when an input signal transitions from a low level to a high level) and falling edge occurring time (time when an input signal transitions from a high level to a low level). Thus, as the length of the clock transmitting line and the number of buffers inserted into the clock transmitting line are increased, the distortion of the duty cycle of the clock signal is increased.

FIG. 1 is a block diagram illustrating a clock signal supplying circuit according to the conventional art. The clock signal supplying circuit of FIG. 1 includes a DLL 1 for generating a clock signal iclk having a duty cycle of 50% in response to an external clock signal eclk and a clock signal driver 2 for dividing a phase of the clock signal iclk to generate an internal clock signal pair pclk and pclkb, as well as a clock transmitting line L to transmit the clock signal of the DLL1 to the clock signal driver 2.

In this, the clock signal supplying circuit generates and outputs the clock signal iclk having a duty cycle of 50% through the DLL1 and generates the internal clock signal pair pclk and pclkb required by the internal circuits through the clock signal driver 2. The clock signal driver 2 is implemented by a phase divider and divides the phase of the clock signal iclk to perform an operation for generating the internal clock signal pair pclk and pclkb. However, the clock signal driver 2 is not able to correct the distorted duty cycle.

FIG. 2 is a timing diagram illustrating an operation of the clock signal supplying circuit illustrated in FIG. 1. Referring to FIG. 2, when the clock signal iclk(n2) input into the clock signal driver 2 is distorted while passing through the clock transmitting line L, even though the DLL1 generates the clock signal iclk(n1) having a duty cycle of 50%, the clock signal driver 2 generates the internal clock signal pair pclk and pclkb having a distorted duty cycle.

In other words, since the conventional clock signal supplying circuit does not include a means for correcting the duty cycle of the clock signal that is distorted while passing through the clock transmitting line, the clock signal driver 2 ends up generating the internal clock signal pair pclk and pclkb with distorted duty cycles, even though the DLL 1 generates the clock signal iclk(n1) having the duty cycle of 50%.

### SUMMARY

It is an object of the present invention to provide a clock signal driver and a clock signal supplying circuit having the same, which corrects the distorted duty cycle of a clock signal when the duty cycle of the clock signal becomes distorted while passing through a clock transmitting line.

An embodiment of the present invention provides a clock signal driver including an internal clock driver. Thje internal clock driver receives a clock signal and a complementary clock signal, buffers the clock signal and inverts the complementary clock signal, and combines the phases of the buffered clock signal and the inverted complementary clock signal, thereby generating an internal clock signal. The clock signal driver also includes a complementary internal clock driver to receive the clock signal and the complementary clock signal, invert the clock signal and buffer the complementary clock signal, and combine the phases of the inverted clock signal and the buffered complementary clock signal to generate a complementary internal clock signal.

### BRIEF DESCRIPTION OF THE DRAWINGS

The above and other features and advantages of the present invention will become more apparent to those of ordinary skill in the art by describing in detail preferred embodiments thereof with reference to the attached drawings, in which:

FIG. 1 is a block diagram illustrating a clock signal supplying circuit according to the conventional art;

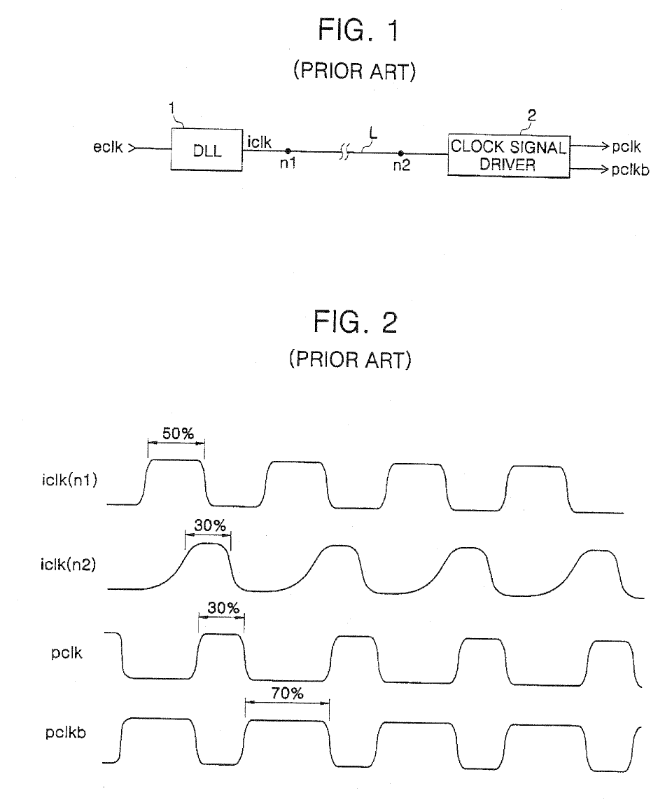

FIG. 2 is a timing diagram illustrating an operation of the clock signal supplying circuit illustrated in FIG. 1;

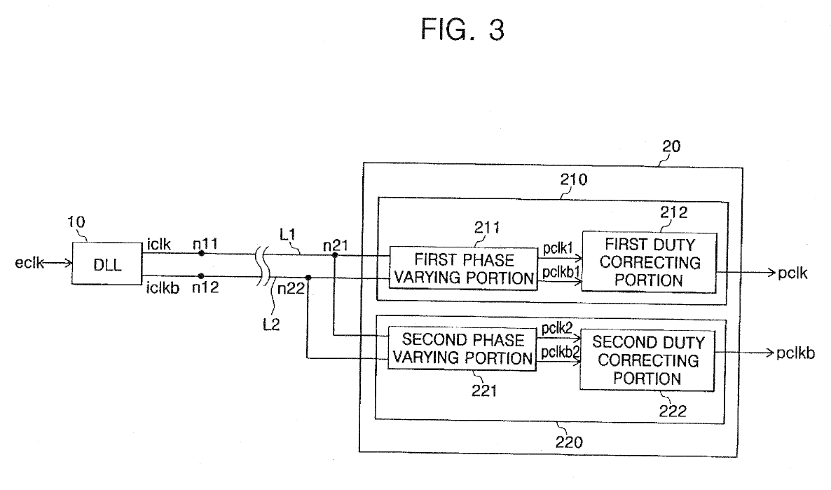

FIG. 3 is a block diagram illustrating a clock signal supplying circuit according to an embodiment of the present invention;

FIG. 4 is a circuit diagram illustrating an embodiment of a clock signal driver according to the present invention; and

FIGS. 5a and 5b are timing diagrams illustrating an operation of the clock signal driver illustrated in FIG. 4.

### DETAILED DESCRIPTION

The present invention will now be described more fully hereinafter with reference to the accompanying drawings, in which embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. Like numbers refer to like elements throughout the specification.

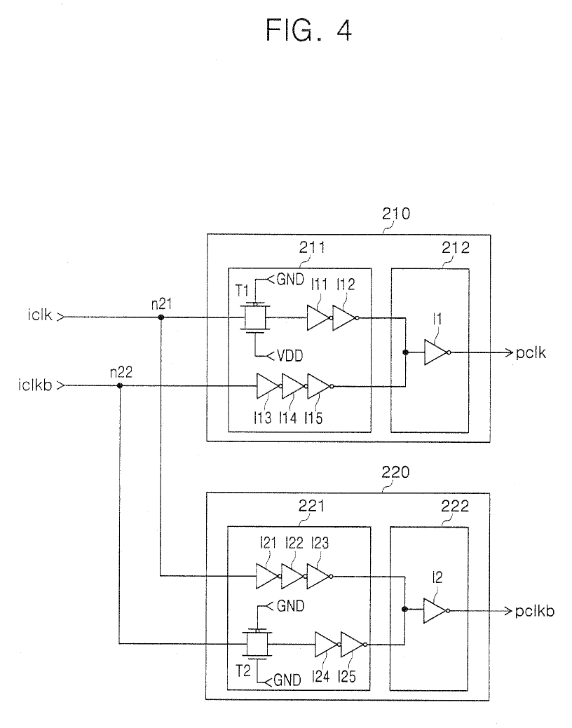

FIG. 3 is a block diagram illustrating a clock signal supplying circuit according to an embodiment of the present invention.

The clock signal supplying circuit of FIG. 3 includes a DLL 10 and a clock signal driver 20. The clock signal driver 20 includes an internal clock driver 210 and a complementary clock driver 220. A clock transmitting line pair L1 and L2 connects the DLL 110 to the clock signal driver 20.

In FIG. 3, the clock transmitting line pair L1 and L2 includes a clock transmitting line L1 for transmitting a clock signal iclk and a clock transmitting line L2 for transmitting a complementary clock signal iclkb. The clock transmitting line L1 and the complementary clock transmitting line L2 have the same delay value and are arranged to be adjacent to each other. Thus, the clock signal pair iclk and iclkb transmitted via the clock transmitting line pair L1 and L2 may have the same delay time and the same duty cycle distortion.

The DLL 10 receives an external clock signal eclk and generates the clock signal pair iclk and iclkb, which may be synchronized to the external clock signal eclk. The clock signal pair iclk and iclkb is a differential signal pair having a duty cycle of 50% and includes a clock signal iclk having substantially the same phase as the external clock signal eclk and a complementary clock signal iclkb having a phase difference of about 180° with the clock signal iclk and the external clock signal eclk.

The internal clock driver 210 receives the clock signal pair iclk and iclkb transmitted from the clock transmitting line pair L1 and L2, buffers the clock signal iclk and inverts the phase of the complementary clock signal iclkb, and then combines the phases of the clock signal iclk and the complementary clock signal iclkb to generate and output the internal clock signal pclk. To this end, the internal clock driver 210 includes a first phase varying portion 211 and a first duty correcting portion 212. The first phase varying portion 211 receives the clock signal pair iclk and iclkb from the clock transmitting line pair L1 and L2, buffers the complementary clock signal iclkb and inverts the complementary clock signal iclkb to thereby generate a first clock signal pair pclk1 and pclkb1. The first duty correcting portion 212 combines the phases of the first clock signal pair pclk1 and pclkb1 to generate a single signal, i.e., the internal clock signal pclk.

The complementary internal clock driver 220 also receives the clock signal pair iclk and iclkb, inverts the clock signal iclk and buffers the complementary clock signal iclkb, and then combines the phases of the clock signal iclk and the complementary clock signal iclkb to generate and output the complementary internal clock signal pclkb. To this end, the internal clock driver 220 includes a second phase varying portion 221 and a second duty correcting portion 222. The second phase varying portion 221 receives the clock signal pair iclk and iclkb from the clock transmitting line pair L1 and L2, inverts the clock signal iclk and buffers the complementary clock signal iclkb to thereby generate a second clock signal pair pclk2 and pclkb2. The second duty correcting portion 222 combines the phases of the second clock signal pair pclk2 and pclkb2 to generate a single signal, i.e., the complementary internal clock signal pclkb.

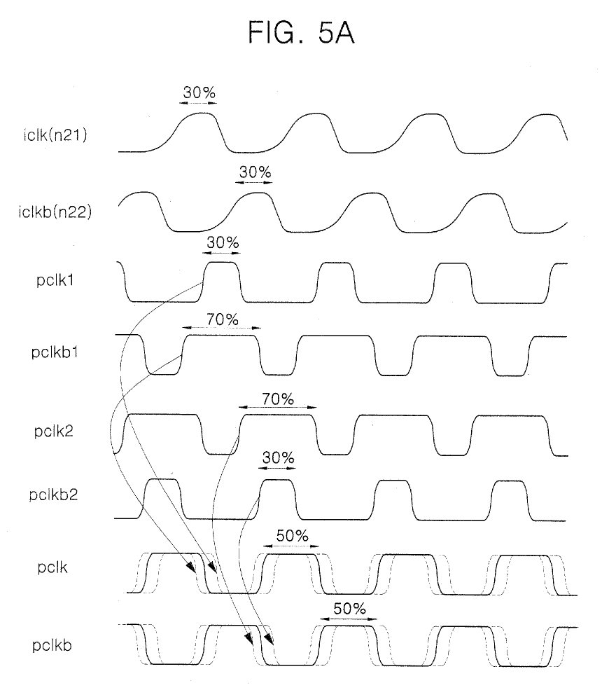

FIG. 4 is a circuit diagram illustrating an embodiment of the clock signal driver according to the present invention.

Referring to FIG. 4, the first phase varying portion 211 of the internal clock driver 210 includes a transmission gate T1 and an even number of inverters I11 and I12, which are serially connected between the clock transmitting line L1 and the first duty correcting portion 212, and an odd number of inverters I13 to I15, which are serially connected between the complementary clock transmitting line L2 and the first duty correcting portion 212. The first duty correcting portion 212 includes an inverter I1 connected to the first phase varying portion 211.

The second phase varying portion 221 of the internal clock driver 220 includes an odd number of inverters I21 to I23, which are serially connected between the clock transmitting line L1 and the second duty correcting portion 222, and a transmission gate T2 and an even number of inverts I24 and I25, which are serially connected between the complementary clock transmitting line L2 and the second duty correcting portion 222. The second duty correcting portion 222 includes an inverter I2 connected to the second phase varying portion 221.

In FIG. 4, the internal clock driver 210 and the complementary internal clock driver 220 have about the same delay value, and the transmission gates T1 and T2 and the inverters I11 to I15, I1, I21 to I25, and I2 have about the same delay value, respectively.

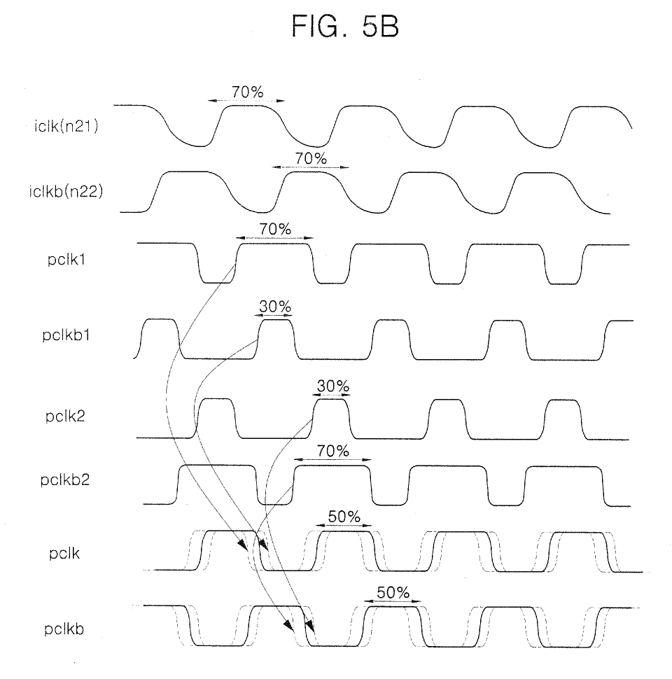

An operation of the clock signal driver according to the present invention will be explained below with reference to FIGS. 5a and 5b.

FIG. 5a shows an operation of the clock signal driver when the duty cycle of clock signal pair is less than 50%.

When the rising edge occurring time of the buffers inserted into the clock transmitting line pair L1 and L2 is greater than the falling edge occurring time, the clock signal pair iclk (n11) and iclkb (n12) of the DLL 10 may have a duty cycle of less than 50% (e.g., 30%) like the clock signal pair iclk (n21) and iclkb (n22) while passing through the clock transmitting line pair L1 and L2.

FIG. 5a shows an operation of the clock signal driver when the duty cycle of clock signal pair is less than 50%.

Referring to FIG. 5a, the transmission gate T1 and the even number of inverters I11 and I12 of the first phase varying portion 211 buffer the clock signal iclk (n21) to generate the first clock signal pclk1, which is delayed by a time t1 and has a duty cycle of about 30%. The odd number of inverters I13 and I15 inverts the complementary clock signal iclkb (n22) to generate the first complementary clock signal pclkb1, which is delayed by the time t1 and has a duty cycle of about 70%. At the same time, the odd number of inverters I21 to I23 of the second phase varying portion 221 inverts the clock signal iclk (n21) to generate the second clock signal pclk2, which is delayed by a time t1 and has a duty cycle of about 70%. The transmission gate T2 and the even number of inverters I24 and I25 of the second phase varying portion 221 buffer the complementary clock signal iclkb (n22) to generate the second complementary clock signal pclkb2, which is delayed by a time t1 and has a duty cycle of about 30%.

The inverter I1 of the first duty correcting portion 212 combines the phases of the clock signal pair pclk1 and pclkb1 of the first phase varying portion 211 to generate the internal clock signal pclk, which is further delayed by a time t2 and has a duty cycle of 50%. Similarly, and the inverter I2 of the second duty correcting portion 222 combines the phases of the clock signal pair pclk2 and pclkb2 of the second phase varying portion 221 to generate the complementary internal clock signal pclkb, which is further delayed by the time t2 and has a duty cycle of 50%.

Here, the time t1 is a delay time according to each delay value of the first and second phase varying portion, and the time t2 is a delay time according to each delay value of the first and second duty correcting portion.

FIG. 5b shows an operation of the clock signal driver when the duty cycle of clock signal pair is greater than 50%.

When the falling edge occurring time of the buffers inserted into the clock transmitting line pair L1 and L2 is greater than the rising edge occurring time, the clock signal pair of the DLL 10 may have a duty cycle of more than 50% (e.g., 70%) like the clock signal pair iclk (n21) and iclkb (n22) while passing through the clock transmitting line pair L1 and L2.

The transmission gate T1 and the even number of inverters I11 and I12 of the first phase varying portion 211 buffer the clock signal iclk (n21) to generate the first clock signal pclk1, which is delayed by a time t1 and has a duty cycle of about 70%. The odd number of inverters I13 and I15 inverts the inverted clock signal iclkb (n22) to generate the first complementary clock signal pclkb1, which is delayed by a time t1 and has a duty cycle of about 30%. At the same time, the odd number of inverters I21 to I23 of the second phase varying portion 221 inverts the clock signal iclk (n21) to generate the second clock signal pclk2, which is delayed by a time t1 and has a duty cycle of about 70%. The transmission gate T2 and the even number of inverters I24 and I25 of the second phase varying portion 221 buffer the inverted clock signal iclkb (n22) to generate the second complementary clock signal pclkb2, which is delayed by a time t1 and has a duty cycle of about 30%.

The inverter I1 of the first duty correcting portion 212 combines the phases of the first clock signal pair pclk1 and pclkb1 of the first phase varying portion 211 to generate the internal clock signal pclk, which is further delayed by the time t2 and has a duty cycle of about 50%. Similarly, the inverter I2 of the second duty correcting portion 222 combines the phases of the clock signal pair pclk2 and pclkb2 of the second phase varying portion 221 to generate the complementary internal clock signal pclkb, which is also further delayed by the time t2 and has the duty cycle of about 50%.

The clock signal driver of the present invention buffers and inverts each of the clock signal pair and then combines a pair of the buffered clock signal and a pair of the non-inverted clock signal in a predetermined pattern to ensure that the clock signal pair has a duty cycle of about 50%. To achieve this, the clock signal driver uses a characteristic that the clock signal pair iclk and iclkb transmitted through the clock transmitting line pair L1 and L2, namely that clock signal pair iclk and iclkb have similar delay times and duty cycle distortions.

As described above, the clock signal driver and the clock signal supplying circuit having the same according to the present invention compensates for the clock signal pair to have the duty cycle of 50% even when the clock signal having a duty cycle of 50% is distorted while passing through the clock transmitting line pair. Thus, the memory device can secure a stable timing margin.

What is claimed is:

1. A clock signal driver, comprising:
an internal clock driver to receive a clock signal and a complementary clock signal, buffer the clock signal, invert the complementary clock signal, and combine phases of the buffered clock signal and the inverted complementary clock signal, thereby generating an internal clock signal; and
a complementary internal clock driver to receive the clock signal and the complementary clock signal, invert the clock signal, buffer the complementary clock signal, and combine phases of the inverted clock signal and the buffered complementary clock signal, thereby generating a complementary internal clock signal.

2. The driver of claim 1, where the internal clock signal and the complementary internal clock signal have similar delay times and a duty cycle of about 50%.

3. The driver of claim 1, where the internal clock driver includes:
a first phase varying portion to receive the clock signal and the complementary clock signal, buffer the clock signal, and invert the complementary clock signal; and
a first duty correcting portion to combine phases of the buffered clock signal and the inverted complementary clock signal to generate the internal clock signal.

4. The driver of claim 3, where the first phase varying portion includes:
a first phase buffer to delay the clock signal by a first time to generate the buffered clock signal; and
a first phase inverter to delay and invert the complementary clock signal by the first time to generate an inverted complementary clock signal.

5. The driver of claim 4, where the first phase buffer includes at least one transmission gate and an even number of inverters to delay the clock signal by the first time.

6. The driver of claim 4, where the first phase inverter includes an odd number of inverters to delay and invert the complementary clock signal by the first time.

7. The driver of claim 3, where the first duty correcting portion includes an inverter to combine phases of the buffered clock signal and the inverted complementary clock signal.

8. The driver of claim 3, where the complementary internal clock driver includes:
a second phase varying portion to receive the clock signal and the complementary clock signal, invert the clock signal, and buffer the complementary clock signal; and
a second duty correcting portion to combine phases of the inverted clock signal and the buffered complementary clock signal to generate the complementary internal clock signal.

9. The driver of claim 8, where the second phase varying portion includes
a second phase inverter to delay and invert the clock signal by the first time to generate the buffered clock signal; and
a second phase buffer to delay the complementary clock signal by the first time to generate a buffered complementary clock signal.

10. The driver of claim 9, where the second phase inverter includes an odd number of inverters to delay and invert the clock signal by the first time.

11. The driver of claim 9, where the second phase buffer includes at least one transmission gate and an even number of inverters to delay the complementary clock signal by the first time.

12. The driver of claim 9, where the second duty correcting portion includes an inverter to combine phases of the inverted clock signal and the buffered complementary clock signal.

13. A clock signal supplying circuit, comprising:
a clock signal generating circuit to receive an external clock signal to generate a clock signal and a complementary clock signal synchronized to the external clock signal;
a clock signal driver to buffer and invert the clock signal and the complementary clock signal, combine phases of the buffered clock signal and the inverted complementary clock signal to generate an internal clock signal, and combine phases of the inverted clock signal and the buffered complementary clock signal to generate a complementary internal clock signal; and
a clock transmitting line pair to transmit the clock signal and the complementary clock signal of the clock generating circuit to the clock signal driver.

14. The circuit of claim 13, where the clock transmitting line pair is adapted to delay and distort the clock signal and the complementary clock signal by a similar amount.

15. The circuit of claim 13, where the internal clock signal and the complementary clock signal have similar delay times and a duty cycle of about 50%.

16. The circuit of claim 13, where the clock signal driver includes:
an internal clock driver to receive the clock signal and the complementary clock signal, buffer the clock signal and invert the complementary clock signal, and combine phases of the buffered clock signal and the inverted complementary clock signal, thereby generating an internal clock signal; and
a complementary internal clock driver to receive the clock signal and the complementary clock signal, invert the clock signal, buffer the complementary clock signal, and combine phases of the inverted clock signal and the buffered complementary clock signal, thereby generating a complementary internal clock signal.

17. The driver of claim 16, where the internal clock driver includes:
a first phase varying portion to receive the clock signal and the complementary clock signal, buffer the clock signal and invert the complementary clock signal; and
a first duty correcting portion to combine phases of the buffered clock signal and the inverted complementary clock signal to generate the internal clock signal.

18. The driver of claim 17, where the first phase varying portion includes:
a first phase buffer to delay the clock signal by a first time to generate the buffered clock signal; and
a first phase inverter to delay and invert the complementary clock signal by the first time to generate an inverted complementary clock signal.

19. The driver of claim 18, where the first phase buffer includes at least one transmission gate and an even number of inverters to delay the clock signal by the first time.

20. The driver of claim 18, where the first phase inverter includes an odd number of inverters to delay and invert the complementary clock signal by the first time.

21. The driver of claim 17, where the first duty correcting portion includes an inverter to combine phases of the buffered clock signal and the inverted complementary clock signal.

22. The driver of claim 16, where the complementary internal clock driver includes:
a second phase varying portion to receive the clock signal and the complementary clock signal, invert the clock signal and buffer the complementary clock signal; and
a second duty correcting portion to combine phases of the inverted clock signal and the buffered complementary clock signal to generate the complementary internal clock signal.

23. The driver of claim 22, where the second phase varying portion includes:
a second phase inverter to delay and invert the clock signal by the first time to generate the buffered clock signal; and
a second phase buffer to delay the complementary clock signal by the first time to generate a buffered complementary clock signal.

24. The driver of claim 23, where the second phase inverter includes an odd number of inverters to delay and invert the clock signal by the first time.

25. The driver of claim 23, where the second phase buffer includes at least one transmission gate and an even number of inverters to delay the complementary clock signal by the first time.

26. The driver of claim 22, where the second duty correcting portion includes an inverter to combine phases of the inverted clock signal and the buffered complementary clock signal.

27. The circuit of claim 13, where the clock signal generating circuit is a phase locked loop (PLL) or a delay locked loop (DLL).

28. A distortion correcting clock signal driver, comprising:
a first clock driver circuit to generate an internal clock signal, the first clock driver circuit including:
a first phase buffer to buffer and delay a clock signal by a first time,
a first phase inverter to invert and delay a complementary clock signal by the first time, and
a first duty correcting circuit to combine the buffered clock signal and the inverted complementary clock signal; and
a second clock driver circuit to generate a complementary internal clock signal, the second clock driver circuit including:
a second phase buffer to buffer and delay the complementary clock signal by the first time,
a second phase inverter to invert and delay the clock signal by the first time, and
a second duty correcting circuit to combine the buffered complementary clock signal and the inverted clock signal.

29. A method of correcting clock signal distortion in a clock signal supplying circuit, the method comprising:
receiving a clock signal and a complementary clock signal at a first clock driver;
buffering the received clock signal;
inverting the received complementary clock signal;
generating an internal clock signal by combining a phase of the buffered clock signal with a phase of the inverted complementary clock signal;
receiving the clock signal and the complementary clock signal at a second clock driver;
buffering the received complementary clock signal;
inverting the received clock signal; and
generating a complementary internal clock signal by combining a phase of the buffered complementary clock signal with a phase of the inverted clock signal.
